(19) United States
(12) Patent Application Publication
(10) Pub. No.: US 2008/0185392 A1
(43) Pub. Date: Aug. 7, 2008

(54) NOVEL DEVICE

(76) Inventors: Gregor John McLennan ANDERSON, Ware (GB); Andrew Kelly, Hitchin (GB); Simon Ritchie, Weybridge (GB); David Robinson, Ware (GB)

Correspondence Address: SMITHKLINE BEECHAM CORPORATION;CORPORATE INTELLECTUAL PROPERTY-US, UW2220, P. O. BOX 1539, KING OF PRUSSIA, PA, 19406-0939, US

(21) Appl. No.: 12/017,360

(22) Filed: Jan. 22, 2008

(30) Foreign Application Priority Data
Jan. 24, 2007 (GB) 0701347.7
Apr. 26, 2007 (GB) 0708128.4

(51) Int. Cl. B65H 3/00; G07F 11/72

(52) U.S. Cl. 221/26; 221/30

(57) ABSTRACT

A dispenser for sachets comprising a container for sachets, having a slot opening communicating with an internal cavity such that a sachet may be inserted into the slot into the cavity, with an abutment surface within the cavity to limit the distance the sachet may extend into the cavity, and a cutter located within the cavity to cut the sachet, preferably on a withdrawal movement so the sachet is in tension. In another embodiment the dispenser dispenses sachets along a dispensing path and a cutter is located in the dispensing path to intercept and cut the sachet.

### FIELD OF THE INVENTION

This invention relates to a dispenser device, in particular to a dispenser device for the dispensing of products contained in sachets.

### BACKGROUND OF THE INVENTION

Products are frequently provided in sachets. Sachets are well known articles, generally comprising two sheets of material joined at their edges to define an envelope volume between them. Sachets are typically made of thin plastics or metal, or metal-plastics material foil laminates. To obtain access to the product contained within the sachet, the sachet must be opened. This is normally achieved by the user tearing the sachet open by hand. Although sachets are often provided with nicks or weakened areas at which they will preferentially tear, opening them can be a haphazard operation with the risk of loss, damage or contamination of the product.

U.S. Pat. No. 4,008,657 discloses an apparatus for dispensing a continuous strip of sachets and is provided with a moveable cutter which cuts the continuous strip to open the sachets to release their contents for use. The disclosed apparatus is a complex machine.

### SUMMARY OF THE INVENTION

It is an object of the present invention to address this problem by providing a dispenser which can conveniently cut open a sachet with some degree of precision as to there the sachet is cut. It is also an object of the invention to provide such a dispenser in a form of a package which can easily be carried about by a person e.g. in a pocket or handbag etc. The latter object is particularly important for sachets containing medicament contents which a user may need during the day, for example a sachet containing a patch to be applied to the skin for the transdermal administration of some therapeutic substance. It is also an object to provide such a package in a form which is cheap to manufacture i.e. requiring minimal moulding and/or assembly. Other objects of this invention will be apparent from the following description.

### DETAILED DESCRIPTION OF THE INVENTION

According to a first form of this invention a dispenser for sachets comprises a container for containing a sachet and from which a sachet may be dispensed for use, the container having a slot opening in its outer surface and communicating with a cavity within the container, the slot opening arranged such that a sachet may be inserted into the slot opening to extend into the cavity, an abutment surface within the cavity to limit the distance the sachet may extend into the cavity, and a cutter located within the cavity and positioned such that a sachet extending into the cavity may be brought into contact with the cutter to thereby cut the sachet.

The slot opening preferably comprises an aperture in the outer surface of the container which approximates to the cross section of the sachet to be inserted through the slot opening. Typically in its cross section perpendicular to the insertion direction in which the sachet is to be inserted into the slot opening such an aperture is relatively long relative to its width. Such a slot opening can conveniently guide a sachet inserted therethrough and into the cavity towards and preferably into contact with the cutter. The slot and/or the cavity may incorporate guide means to further guide an inserted sachet towards and preferably into contact with the cutter. Such guide means may for example comprise internal ribs within the cavity which define a path for the sachet within the cavity.

An abutment surface within the cavity to limit the distance the sachet may extend into the cavity may be provided in various ways. In one way the abutment surface is provided by a bulkhead wall of the cavity, or internal ribs within the cavity, against which the sachet abuts when the sachet extends into the cavity to a desired extent. This abutment surface can function to determine the extent to which the sachet and cutter can be relatively moved in cutting contact so as to consequently determine the extent to which the sachet is cut. For example the dispenser may be arranged to cut only a starting nick in the sachet to provide a starting point for the user to tear the sachet fully open. Alternatively the dispenser may be arranged to cut the sachet fully open by severing a segment of the sachet. Additionally or alternatively the abutment surface can function as a guide surface to guide the sachet into cutting contact with the cutter within the cavity as described below.

The cutter is located within the cavity and positioned such that a sachet extending into the cavity and the cutter may be brought into contact with each other to thereby cut the sachet. In this first embodiment the cutter may be configured and positioned within and relative to the cavity and the abutment in various constructions to cut the sachet in various alternative constructions.

In a first construction the cutter is positioned and aligned within the cavity such that the sachet may be brought into contact with the cutter by a movement of the sachet within the cavity in a first direction, and then brought out of contact with the cutter by a reciprocal movement of the sachet in an opposite second direction.

In this first construction the cutter may be arranged to cut the sachet either on the movement of the sachet in the first direction or in the second direction.

As sachets are typically flexible and liable to crumple under compression such an arrangement can advantageously be used to cause the sachet to be cut whilst the sachet is under tension. This may be achieved by a cutter configured to cut the sachet whilst the sachet is moved, e.g. pulled, in the second direction out of contact with the cutter.

For example the first direction may be the insertion direction in which the sachet is inserted into the slot opening and the second direction may be the withdrawal direction in which the sachet is withdrawn from the slot opening. In such a construction the abutment surface functions to limit the distance the sachet can be inserted into the cavity in the insertion direction, and consequently the distance the sachet needs to be withdrawn from the cavity and slot opening, and hence the extent to which the sachet is cut.

Alternatively for example both the first and second directions may be directions perpendicular to the insertion direction, such that the sachet is inserted into the slot opening in an insertion direction, then brought into contact with the cutter by a movement of the sachet within the cavity in a first direction perpendicular to this insertion direction, and then brought out of contact with the cutter by a reciprocal movement of the sachet in an opposite second direction perpendicular to the insertion direction, and then withdrawn from the slot opening in a withdrawal direction. In such a construction the abutment surface can be aligned to guide the sachet in sliding contact with the abutment surface as the sachet is moved in the first and second directions perpendicular to the insertion direction.

This cutting action on movement of the sachet in the second direction may be achieved in various ways. For example the cutter may have a cutting edge which faces in the first, e.g. insertion, direction and a non-cutting surface facing in the second, e.g. withdrawal, direction. For example the container may have a slot opening into which the sachet may be inserted in an insertion direction and withdrawn in an opposite reciprocal withdrawal direction, and the cutter has a cutting edge facing in the insertion direction away from the slot opening.

This first construction of the dispenser of the invention is suitable to cut a starting nick in the sachet.

In a second construction the cavity defines a linear guide groove having the slot opening at an insertion end of the groove and having an exit opening at an exit end of the groove, such that the sachet may be inserted into the groove via the slot opening, moved along the groove from the slot opening toward the exit opening, and then to exit from the cavity via the exit opening, and the cutter is located within the cavity between the slot opening and exit opening with its cutting edge aligned with the guide groove such that the cutter intercepts the sachet as the sachet moves along the groove and the cutter cuts the sachet.

In this second construction the sachet is in effect “swiped” along this guide groove.

In this second construction the abutment surface can limit the distance to which the sachet can be inserted into the cavity, i.e. the guide groove, and is suitably aligned so that the sachet may be passed through the guide groove in sliding contact with the abutment surface so that the abutment surface functions to guide the sachet. The cutter is positioned at a distance from the abutment surface so that the cutter cuts the sachet at a corresponding distance from the edge of the sachet which moves in sliding contact with the abutment surface.

This second construction of the dispenser of the invention is suitable to cut a starting nick in the sachet or to cut the sachet completely open by severing a segment of the sachet.

In a third construction the cutter is moveably mounted relative to the cavity so that the cutter may be moved relative to a sachet to thereby cut open the sachet.

In this construction suitably the slot opening, cavity and moveably mounted cutter are relatively disposed such that a sachet may be inserted into the cavity in an insertion direction via the slot opening to abut against the abutment surface, and the cutter is moveable in a direction perpendicular to the insertion direction.

The extent of moveability of the cutter may be such that the cutter only cuts a starting nick in the sachet, or alternatively that the cutter completely severs a segment of the sachet to thereby open the sachet.

Ways of moveably mounting the cutter will be apparent to those skilled in the art. In one way the cutter may be slideably moveably mounted in a guide slot, suitably having an operating handle external to the container by which the cutter may be operated.

In this third construction the abutment surface can function to limit the distance the sachet can be inserted into the cavity in the insertion direction, and the distance in the insertion direction between the cutter and the abutment surface can determine the corresponding distance from the edge of the sachet at which the sachet is cut.

In a second embodiment of the invention a dispenser for sachets is provided comprising a container for containing a sachet and from which a sachet may be dispensed for use, the container body incorporating a cutter with which a sachet dispensed from the container may be brought into contact to thereby cut open the sachet, the dispenser being constructed to dispense a sachet along a dispensing path, and the cutter may be mounted to intercept a sachet traveling along this dispensing path to thereby cut open the sachet.

Such a dispensing path may be defined by a dispensing conduit along which the sachet is dispensed towards a dispensing outlet opening.

In this third embodiment the sachet may have a straight edge, e.g. it may be rectangular, and the direction of the dispensing path may be parallel to the straight edge direction of the sachet.

In use, a sachet may be dispensed from the container of this third embodiment along the dispensing path, and in the course of following the dispensing path the sachet is brought into contact with the cutter to thereby cut the sachet.

The cutter may comprise a sharp blade, e.g. made of metal or ceramic.

Preferably the cutter is shielded to prevent accidental contact with the user and consequent injury. This may be achieved for example by mounting the cutter deep within the cavity so that a user's fingers cannot be easily inserted through the slot opening to contact the cutter. This shielding is also achieved in forms of the dispenser of the invention in which the cutting edge of the cutter faces away from the insertion direction.

Suitable relative positions of the slot opening, cavity and cutter can easily be determined empirically by those skilled in the art to cut any specific sachet at a suitable position and to a suitable extent.

The dispenser of the invention is preferably in the form of a package which can be easily be carried about by a person e.g. in a pocket or handbag etc. Such a package may be made of commonly used packaging materials, for example plastics materials, metal or stiff cardboard. Suitable shape and dimensions for such a package will be apparent to those skilled in the packaging art. An overall preferred configuration of the dispenser of the first embodiment suitably comprises an elongate tetragonal, i.e. flattened box shape, preferably with rounded corners and edges, having a dispensing opening for the sachets at one end surface and the slot opening, aperture etc. at the opposite longitudinal surface.

Consequently an overall preferred form of the dispenser of this invention is one according to the first embodiment and comprises a tetragonal container having a dispensing opening for the sachets at one surface of the container and the slot opening at the opposite surface, the slot opening comprising an aperture in the outer surface of the container being relatively long relative to its width, the cavity incorporating guide means to guide an inserted sachet towards and into contact with the cutter, the abutment surface positioned to limit the extent to which a sachet can be inserted in the insertion direction into the cavity, the cutter configured such that the sachet is brought into contact with the cutter by a movement of the sachet within the cavity in the insertion direction, and then brought out of contact with the cutter by a reciprocal movement of the sachet in the withdrawal direction, the cutter having a cutting edge facing in the insertion direction to cut the sachet on the movement of the sachet in the withdrawal direction.

By means of the dispenser of the invention sachets may be easily cut open without the risks encountered in tearing them open by hand. Sachets are typically generally rectangular (the term includes square) and in the dispenser of the invention the cutter may be so incorporated into the dispenser such that the sachet can be cut parallel to a straight edge of such a rectangular sachet.

### BRIEF DESCRIPTION OF DRAWINGS

The invention will now be described by way of example only with reference to the accompanying drawings.

FIGS. 1-3 show a dispenser of the first embodiment.

FIGS. 4-6 show the operation of the dispenser of FIG. 1.

FIGS. 7-11 show an alternative form of dispenser of the first embodiment.

FIGS. 12-15 show an alternative form of dispenser of the first embodiment

FIGS. 16-20 show an alternative form of dispenser of the first embodiment

FIGS. 21-23 show an alternative form of dispenser of the first embodiment

FIGS. 24-26 show a dispenser of the second embodiment

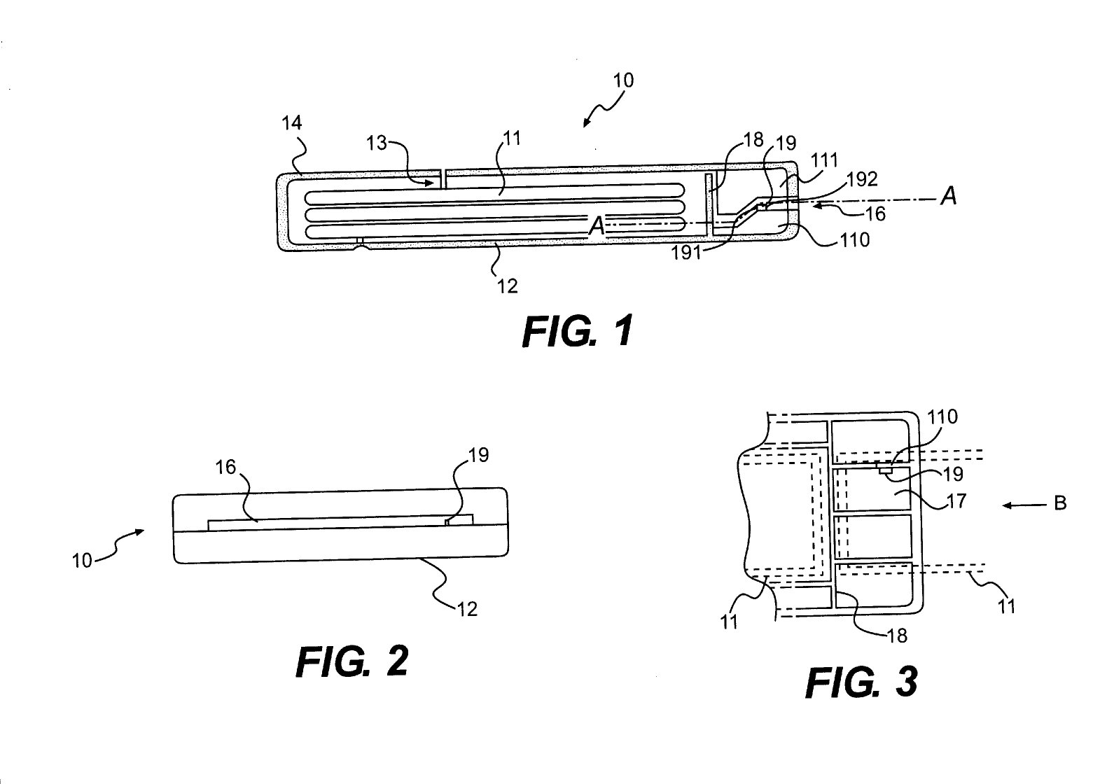

Referring to FIGS. 1-6 a dispenser 10 overall for sachets 11 is shown in a longitudinal section view in FIG. 1, in a part plan sectional view as cut along the line A-A and seen looking downwards in FIG. 2, and in an end looking in the longitudinal direction along the direction B in FIG. 3. Dispenser 10 comprises a container 12 being of a generally tetragonal box shape with rounded edges and corners, capable of containing plural sachets 11 and from which sachets may be dispensed for use from a dispensing opening 13 closed with a hinged closure 14. The container incorporates internal ribs 15 to define a containing space more closely accommodated to the shape of sachets 11 contained therein. The container 12 is conventionally moulded in plastics material such as polypropylene and is conveniently made in two mating upper and lower parts 121, 121 meeting at a seam line 123.

The container 12 is of an overall tetragonal shape and has a slot opening 16 in its outer end surface, which as seen in FIG. 2 comprises an aperture in the outer surface of the container 12 at the longitudinally opposite end to the dispensing opening 13, and the slot opening 16 approximates to the cross section of the sachet 11 to be inserted in the insertion direction being the longitudinal direction of the dispenser 10 through the slot opening 16, being relatively long relative to its width.

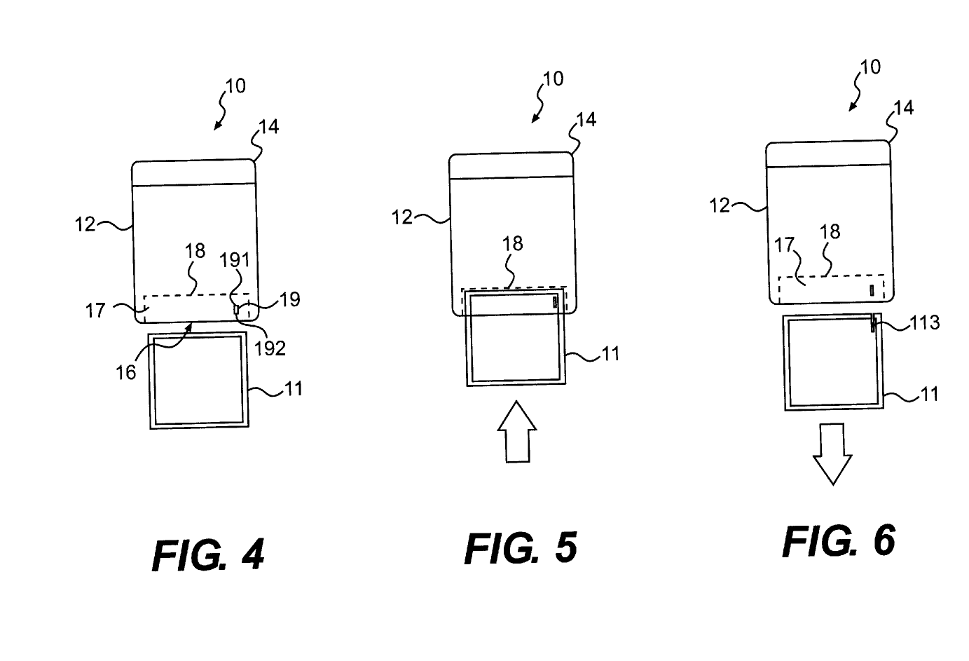

The slot opening 16 communicates with a cavity 17 within the container 12. As more clearly seen in FIGS. 4, 5 and 6 which show simplified plan views with the outline of cavity 17 shown in dotted outline the slot opening 16 is arranged such that a sachet 11 may be inserted in an insertion direction as shown by the arrow in FIG. 5 into the slot opening 16 to extend into the cavity 17. An abutment surface within the cavity 17 is provided by a bulkhead wall 18 which limits the distance the sachet 11 may extend in the insertion direction into the cavity 17 by abutment of the leading edge of the sachet 11 against the bulkhead wall 18. A cutter 19 is located within the cavity 17. The cutter 19 is attached to a rib 110 which serves both as a mounting for the cutter 19 and together with other ribs 111 define a path 112 for the sachet 11 within the cavity. This path 112 is angled, with the cutter 19 located in a concave part of the path 112.

The cutter 19 is positioned and aligned within the cavity 17 such that the sachet 11 is brought into contact with the cutter 19 in the insertion direction, and is then brought out of contact with the cutter 19 by a reciprocal movement of the sachet in the opposite withdrawal direction being the direction of the arrow in FIG. 6.

The cutter 19 has a cutting edge 191 which faces in the insertion direction away from the slot opening 16 and a non-cutting surface 192 facing in the withdrawal direction. The cutter 19 has a sawtooth profile and the non-cutting surface 192 is inclined at a non-perpendicular angle to the insertion direction so that the sachet 11 can ride over the non-cutting surface 192 without being cut, but being scored.

In operation as seen in FIGS. 4, 5 and 6 the sachet 11 is first inserted as seen in FIGS. 3 and 5 into the slot opening 16 in the insertion direction until the sachet 11 abuts against the wall 18. As the sachet is inserted it follows the path 112 and rides over the non-cutting surface 192 of the cutter 19 so as to be scored. The sachet is then withdrawn in the withdrawal direction as seen in FIG. 6. Because the path 112 is an angled path with the cutter 19 located in the convexity of the angle, the tension in the sachet 11 as it is pulled in the withdrawal direction urges the sachet 11 into cutting contact with the cutting edge 191 of cutter 19. As a result a nick 113 is cut in the sachet 11 which a user may use to tear open the sachet 11.

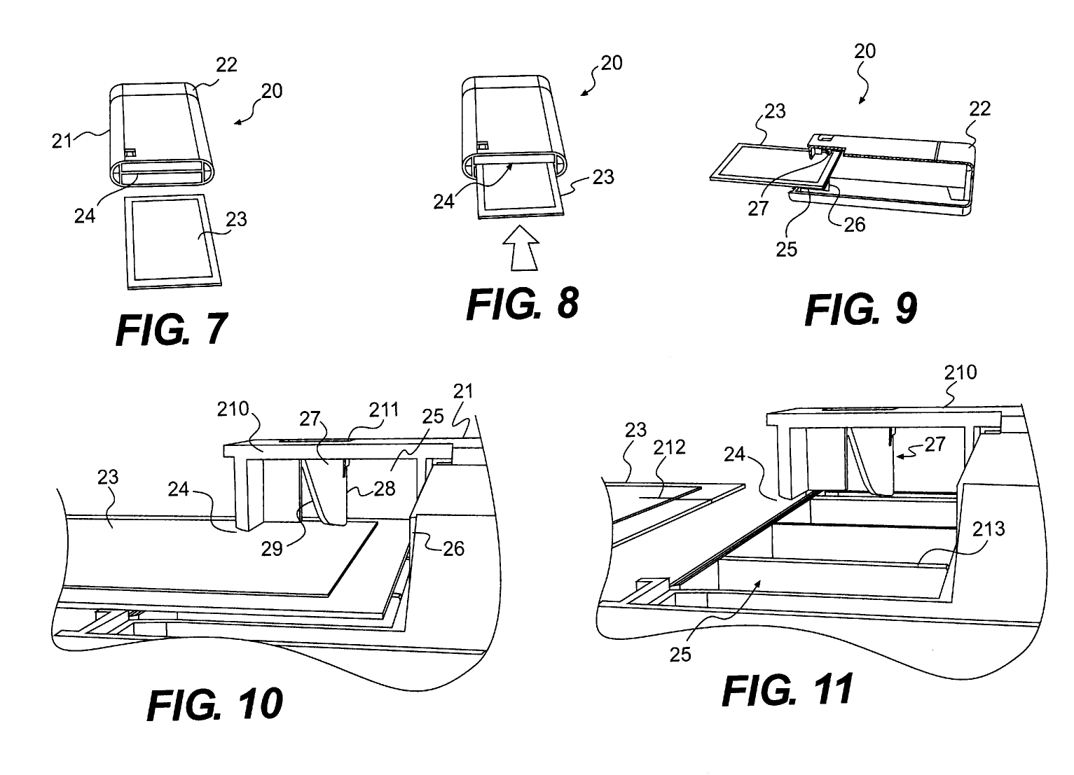

Referring to FIGS. 7-11, an alternative form of the dispenser of the first embodiment is shown in perspective views in FIGS. 7 and 8, and in partially opened perspective views in FIGS. 9, 10 and 11.

The dispenser 20 overall comprises a container 21 of generally known tetragonal box type with an openable closure 22 which may be opened to enable a user to access a rectangular sachet 23 therefrom. The container 21 has a slot opening 24 in its outer surface, comprising an elongate aperture extending partly across the width of the container 21 and communicating with a cavity 25 within the container.

The cavity 25 has an end-stop abutment 26 comprising an end wall of the cavity 25. As is seen in FIGS. 8 and 9 a sachet 23 inserted into the slot opening 24 and extending into cavity 25 abuts against this abutment 26 when inserted in the insertion direction being the arrow in FIG. 8. This abutment limits the extent to which the sachet 23 can be inserted into the cavity 25.

A cutter 27 is located in the cavity 25. The cutter 27 comprises a metal cutting edge 28 on the side of cutter 27 facing away from the slot opening 24, and has a blunt plastics material non-cutting edge 29 facing the slot opening 24. The cutter 27 is mounted resiliently relative to the wall 210 defining the container 21 by means of the resilient plastics material flap 211.

As seen in FIG. 10, as the sachet 23 is inserted into the slot opening 24 the sachet 23 is brought into contact with the non-cutting edge 29 of cutter 27. This causes the cutter 27 to be displaced resiliently, and the cutter 27 merely scores the sachet 23. As is seen in FIG. 11, when the sachet is withdrawn from the slot opening 24 in the withdrawal direction the cutting edge 28 of cutter 27 contacts the sachet to cut a notch 212 in the sachet 23. The cavity 25 is provided with internal ribs 213 to guide the sachet 23 as it is inserted into cavity 25. It is seen that the sachet 23 is cut whilst the sachet 23 is under tension, being pulled in the withdrawal direction out of the slot 25.

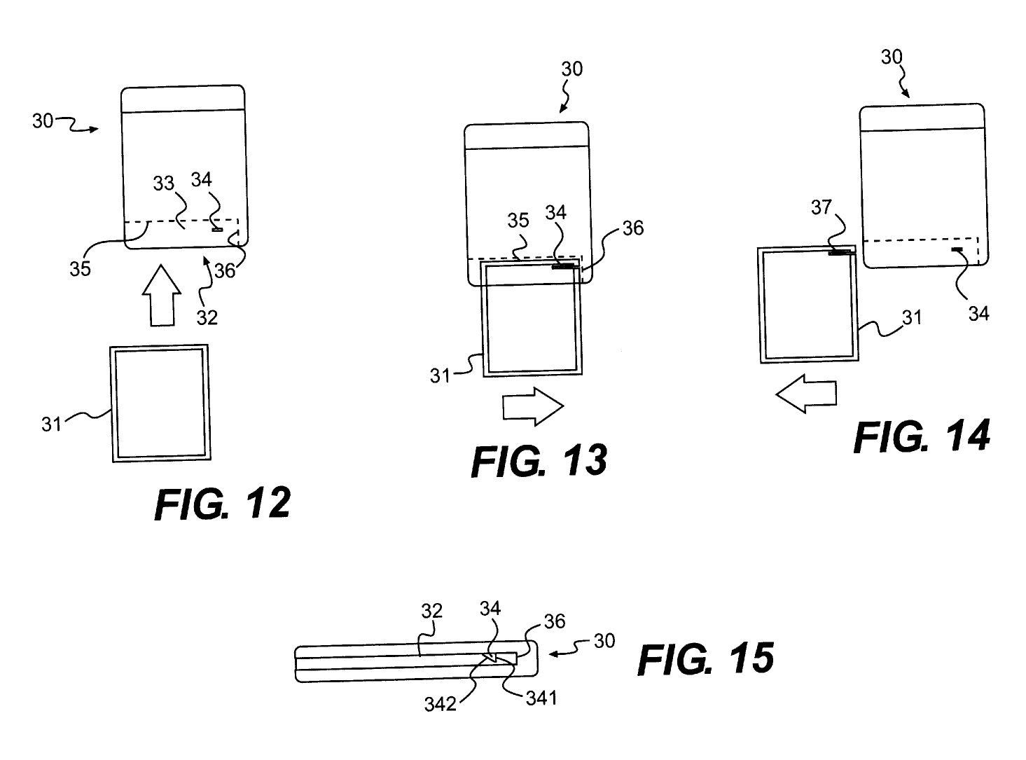

Referring to FIGS. 12, 13, 14 and 15 another alternative form of the dispenser 30 overall, being again of generally tetragonal shape with rounded edges and corners, is shown. FIGS. 12, 13 and 14 are plan views showing some internal features in dotted outline. FIG. 15 is an end view looking in the insertion direction shown by the arrow in FIG. 12. In a manner analogous to FIGS. 1-11 a sachet 31 is inserted into the slot opening 32 communicating with the internal cavity 33 within which is located a cutter 34 of analogous construction to that 19 shown in FIGS. 1-6.

However in the dispenser of FIGS. 12-15 the cutting edge 341 of cutter 34 is oriented in a direction perpendicular to the insertion direction.

In use, a sachet 31 is inserted through the slot opening 32 in the insertion direction being the arrow shown in FIG. 12. The sachet then abuts against the abutment surface 35 being a bulkhead wall of the cavity 33 analogous to that 18 of FIGS. 1-6. This abutment limits the distance the sachet 31 can be inserted in this direction.

As seen in FIG. 13 the sachet 31 is then moved in a first direction shown by the arrow in FIG. 13 perpendicular to the insertion direction in which it is brought into contact with the non-cutting surface 342 of cutter 34 in a manner analogous to FIGS. 1-6. The abutment surface 35 is aligned to guide the sachet 31 in sliding contact with the abutment surface 35 as the sachet 31 is moved in this first direction, until the sachet abuts against a further abutment surface 36 being an end of the cavity 33. The sachet 31 is then brought out of contact with the cutter 34 by a reciprocal movement of the sachet in an opposite second direction perpendicular to the insertion direction shown by the arrow in FIG. 14, and engages with the cutting edge 341 of the cutter 34, which faces in the first direction, to be cut in a manner analogous to FIG. 6. The sachet 31 may then be withdrawn from the cavity 33 in a withdrawal direction which may be a direction opposite to the arrow in FIG. 12, or a continued movement in the direction of the arrow of FIG. 14. It is seen in FIG. 14 that a starting nick 37 has been cut in the sachet to provide a starting point for the user to tear the sachet 33 fully open.

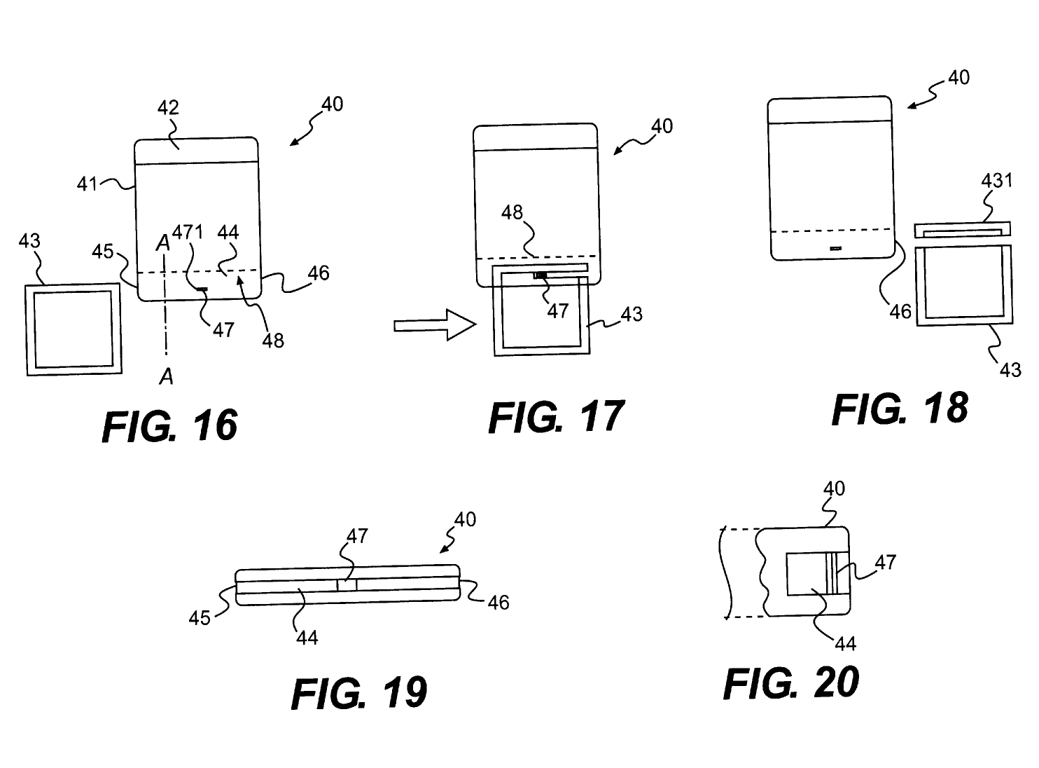

Referring to FIGS. 16-20, a dispenser 40 overall of the first embodiment comprises a container 41 of generally known box type with an openable closure 42 which may be opened to enable a user to access a sachet 43 therefrom. FIGS. 16, 17 and 18 show plan views, with concealed internal features shown by dashed lines. FIG. 19 is an end view looking at the dispenser upwardly as drawn. FIG. 20 is a cross-sectional view of the lower end (as seen) of the container as cut along the line A-A of FIG. 16.

In the dispenser 40 a cavity is in the form of a linear guide groove 44 having a slot opening 45 at an insertion end of the groove 44 and having an exit opening 46 at an exit end of the groove 44. As seen in FIG. 17 a sachet 43 may be inserted into the groove 44 via the slot opening 45 in the direction shown by the arrow in FIG. 17 and moved in this direction along the groove 44 from the slot opening 45 toward the exit opening 46, and to exit from the groove 44 via the exit opening 46. A cutter 47 is located within the groove 44 between the slot opening 45 and exit opening 46 with its cutting edge 471 aligned with the guide groove 44 such that the cutter 47 intercepts the sachet 43 as the sachet 43 moves along the groove 44 and the cutter 47 cuts the sachet 43.

In the dispenser 40 an abutment surface 48 is provided being a side surface of the groove 44, and is aligned so that the sachet 43 may be passed through the guide groove 44 in sliding contact with the abutment surface 48 so that the abutment surface 48 functions to guide the sachet 43. The abutment surface 48 also limits the distance the sachet 43 can be inserted into the groove 44. The cutter 47 is positioned at a distance from the abutment surface 48 so that the cutter 47 cuts the sachet 43 at a corresponding distance from the edge of the sachet 43 which moves in sliding contact with the abutment surface 48.

As seen in FIG. 18 the dispenser of the invention is suitable to cut the sachet completely open by severing a segment 431 of the sachet. By a less complete movement of the sachet along the groove 44 the cutter 47 may be used to cut only a starting nick in the sachet 43.

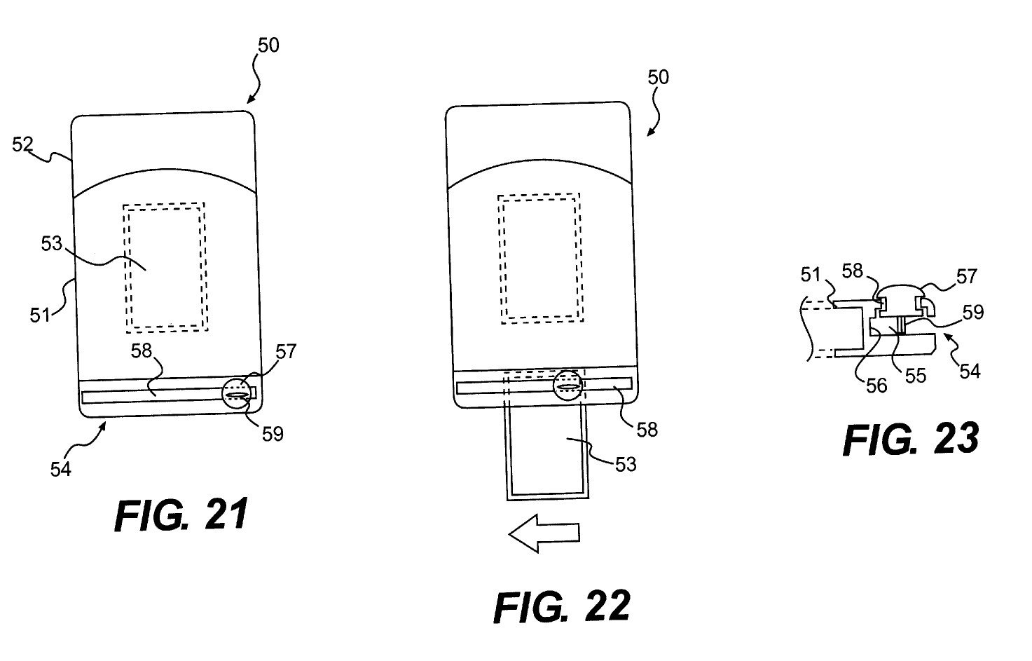

Referring to FIGS. 21, 22 and 23 a dispenser 50 overall is shown. This comprises a container 51 of generally known box type with an openable closure 52 which may be opened to enable a user to access a sachet 53 therefrom. FIGS. 21 and 22 show orthogonal views, with concealed internal features shown by dashed lines. FIG. 23 is a cross-sectional view of the lower end (as seen) of the container 51 as cut along the line B-B of FIG. 5.

In this dispenser the container 51 has a slot opening 54 in its outer surface communicating with cavity 55 into which a sachet 53 may be inserted as seen in FIG. 22. The cavity 55 has an end stop abutment 56 being a side surface of the cavity 55, such that the sachet 53 may be inserted into the cavity 55 such that its edge abuts against the surface 56 to limit the distance the sachet 53 can be inserted into the cavity 55. The sachet 53 has a straight edge, being rectangular.

A cutter 57 is moveably mounted relative to the cavity 55 by a snap fitting of the edge of the cutter 57 into a guide slot 58 in a side wall of the cavity 55. The cutter 57 incorporates a sharp metal cutting blade 59 extending across most of the cavity 55. The blade 58 may be moved within the cavity 55 relative to the sachet 53 therein, in the direction of the arrow shown in FIG. 22 to thereby cut open the sachet 53 and to sever a segment of the sachet 53 analogous to FIG. 18.

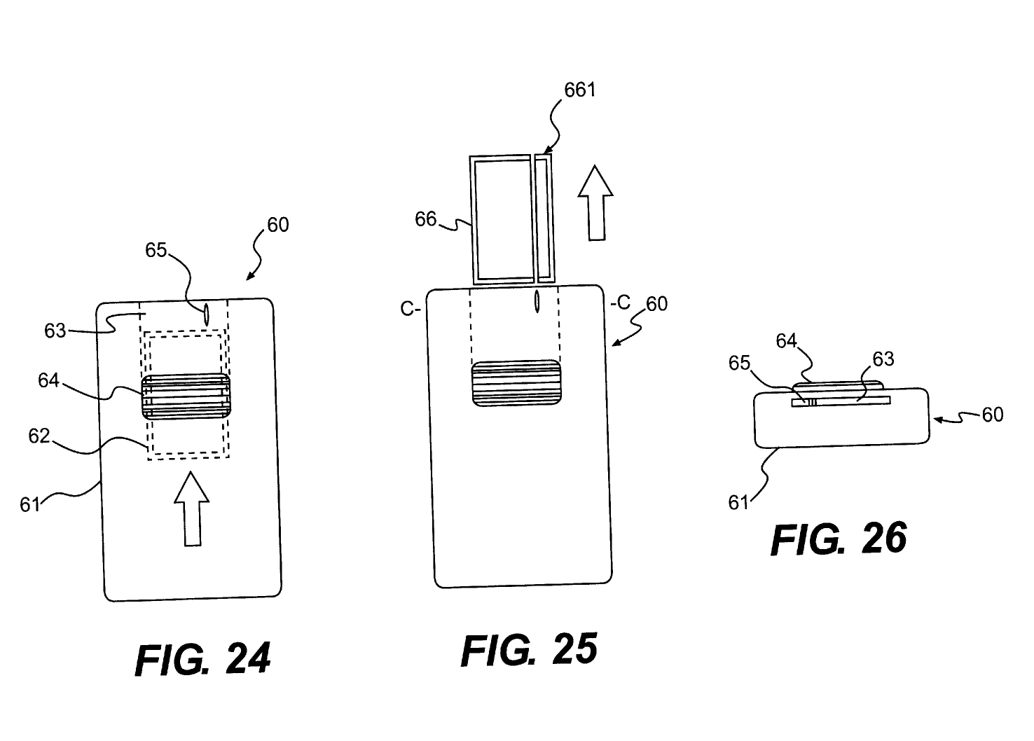

Referring to FIGS. 24, 25 and 26, a dispenser of the second embodiment shown overall 60 comprises a container 61 of generally known box type, which contains sachets 62 which can be dispensed therefrom along a dispensing path 63, being a channel more clearly seen in FIG. 26, by means of a known type of roller dispensing mechanism operated from outside the container 61 by roller 64. FIGS. 24 and 25 show orthogonal views, with concealed internal features shown by dashed lines. FIG. 26 is a cross-sectional view across the dispensing path, of the container as cut along the line C-C of FIG. 25.

A cutter 65 being a sharp metal blade is mounted across dispensing path 63 to intercept a sachet 62 traveling along this dispensing path 33 to thereby cut open the sachet by severing the segment 661.

In this second embodiment the sachet 62 has a straight edge, being rectangular, and the direction of the dispensing path 63 is parallel to the long straight edge direction of the sachet 62.

A typical size for the generally tetragonal dispensers 10, 20, 30, 40, 50, 60 is ca. 10 cm (longitudinal direction)×6 cm (width direction)×1.7 cm (depth direction). These dimensions are generally suitable for sachets to contain a medicinal patch e.g. a transdermal patch, and convenient for carrying in a pocket or handbag etc. A suitable manufacturing material is polypropylene. It is clearly seen from FIGS. 1-26 how the sharp blade of the cutter is shielded by being mounted within the cavity or in the dispensing path to prevent accidental contact with the user and consequent injury.

1. A dispenser for sachets which comprises a container for containing a sachet and from which a sachet may be dispensed for use, the container having a slot opening in its outer surface and communicating with a cavity within the container, the slot opening arranged such that a sachet may be inserted into the slot opening to extend into the cavity, an abutment surface within the cavity to limit the distance the sachet may extend into the cavity, and a cutter located within the cavity and positioned such that a sachet extending into the cavity may be brought into contact with the cutter to thereby cut the sachet.

2. A dispenser according to claim 1 characterised in that the abutment surface is provided by a bulkhead wall of the cavity, or internal ribs within the cavity, against which the sachet abuts when the sachet extends into the cavity to a desired extent.

3. A dispenser according to claim 1 characterised in that the cutter is positioned within the cavity such that the sachet may be brought into contact with the cutter by a movement of the sachet within the cavity in a first direction, and then brought out of contact with the cutter by a reciprocal movement of the sachet in an opposite second direction.

4. A dispenser according to claim 3 characterised in that the cutter is configured to cut the sachet whilst the sachet is moved in the second direction out of contact with the cutter.

5. A dispenser according to claim 4 characterised in that the first direction is the insertion direction in which the sachet is inserted into the slot opening and the second direction is the withdrawal direction in which the sachet is withdrawn from the slot opening.

6. A dispenser according to claim 5 characterised in that the abutment surface limits the distance the sachet can be inserted into the cavity in the insertion direction.

7. A dispenser according to claim 4 characterised in that both the first and second directions are directions perpendicular to the insertion direction of the sachet, such that the sachet is inserted into the slot opening in an insertion direction, then brought into contact with the cutter by a movement of the sachet within the cavity in a first direction perpendicular to this insertion direction, and then brought out of contact with the cutter by a reciprocal movement of the sachet in an opposite second direction perpendicular to the insertion direction, and then withdrawn from the slot opening in the withdrawal direction.

8. A dispenser according to claim 7 characterised in that the abutment surface is aligned to guide the sachet in sliding contact with the abutment surface as the sachet is moved in the direction perpendicular to the insertion direction.

9. A dispenser according to claim 3 characterised in that the cutter has a cutting edge which faces in the first direction and a non-cutting surface facing in the second direction.

10. A dispenser according to claim 9 characterised in that the dispenser has a slot opening into which the sachet may be inserted in an insertion direction and withdrawn in an opposite reciprocal withdrawal direction, and the cutter has a cutting edge facing in the insertion direction away from the slot opening.

11. A dispenser according to claim 1 characterised in that the cavity defines a linear guide groove having the slot opening at an insertion end of the groove and having an exit opening at an exit end of the groove, such that the sachet may be inserted into the groove via the slot opening, moved along the groove from the slot opening toward the exit opening, and to exit from the cavity via the exit opening, and the cutter is located within the cavity between the slot opening and exit opening with its cutting edge aligned with the guide groove such that the cutter intercepts the sachet as the sachet moves along the groove and the cutter cuts the sachet.

12. A dispenser according to claim 11 characterised in that the abutment surface is aligned so that the sachet may be passed through the guide groove in sliding contact with the abutment surface so that the abutment surface functions to guide the sachet.

13. A dispenser according to claim 1 characterised by a cutter moveably mounted relative to the cavity so that the cutter may be moved relative to a sachet to thereby cut open the sachet.

14. A dispenser according to claim 13 characterised in that the slot opening, cavity and moveably mounted cutter are relatively disposed such that a sachet may be inserted into the cavity in an insertion direction via the slot opening to abut against the abutment surface, and the cutter is moveable in a direction perpendicular to the insertion direction.

15. A dispenser for sachets comprising a container for containing a sachet and from which a sachet may be dispensed for use, the container body incorporating a cutter with which a sachet dispensed from the container may be brought into contact to thereby cut open the sachet, the dispenser being constructed to dispense a sachet along a dispensing path, and the cutter may be mounted to intercept a sachet traveling along this dispensing path to thereby cut open the sachet.

16. A dispenser according to claim 15 characterised in that the dispensing path is defined by a dispensing conduit along which the sachet is dispensed towards a dispensing outlet opening.

17. A dispenser according to claim 1 in the form of a package.

18. A dispenser according to claim 1, characterised by comprising a tetragonal container having a dispensing opening for the sachets at one surface of the container and the slot opening at the opposite surface, the slot opening comprising an aperture in the outer surface of the container being relatively long relative to its width, the cavity incorporating guide means to guide an inserted sachet towards and into contact with the cutter, the abutment surface positioned to limit the extent to which a sachet can be inserted in the insertion direction into the cavity, the cutter configured such that the sachet is brought into contact with the cutter by a movement of the sachet within the cavity in the insertion direction, and then brought out of contact with the cutter by a reciprocal movement of the sachet in the withdrawal direction, the cutter having a cutting edge facing in the insertion direction to cut the sachet on the movement of the sachet in the withdrawal direction.

19. A dispenser according to claim 2, characterised by comprising a tetragonal container having a dispensing opening for the sachets at one surface of the container and the slot opening at the opposite surface, the slot opening comprising an aperture in the outer surface of the container being relatively long relative to its width, the cavity incorporating guide means to guide an inserted sachet towards and into contact with the cutter, the abutment surface positioned to limit the extent to which a sachet can be inserted in the insertion direction into the cavity, the cutter configured such that the sachet is brought into contact with the cutter by a movement of the sachet within the cavity in the insertion direction, and then brought out of contact with the cutter by a reciprocal movement of the sachet in the withdrawal direction, the cutter having a cutting edge facing in the insertion direction to cut the sachet on the movement of the sachet in the withdrawal direction.

20. A dispenser according to claim 3, characterised by comprising a tetragonal container having a dispensing opening for the sachets at one surface of the container and the slot opening at the opposite surface, the slot opening comprising an aperture in the outer surface of the container being relatively long relative to its width, the cavity incorporating guide means to guide an inserted sachet towards and into contact with the cutter, the abutment surface positioned to limit the extent to which a sachet can be inserted in the insertion direction into the cavity, the cutter configured such that the sachet is brought into contact with the cutter by a movement of the sachet within the cavity in the insertion direction, and then brought out of contact with the cutter by a reciprocal movement of the sachet in the withdrawal direction, the cutter having a cutting edge facing in the insertion direction to cut the sachet on the movement of the sachet in the withdrawal direction.

21. A dispenser according to claim 4, characterised by comprising a tetragonal container having a dispensing opening for the sachets at one surface of the container and the slot opening at the opposite surface, the slot opening comprising an aperture in the outer surface of the container being relatively long relative to its width, the cavity incorporating guide means to guide an inserted sachet towards and into contact with the cutter, the abutment surface positioned to limit the extent to which a sachet can be inserted in the insertion direction into the cavity, the cutter configured such that the sachet is brought into contact with the cutter by a movement of the sachet within the cavity in the insertion direction, and then brought out of contact with the cutter by a reciprocal movement of the sachet in the withdrawal direction, the cutter having a cutting edge facing in the insertion direction to cut the sachet on the movement of the sachet in the withdrawal direction.

22. A dispenser according to claim 5, characterised by comprising a tetragonal container having a dispensing opening for the sachets at one surface of the container and the slot opening at the opposite surface, the slot opening comprising an aperture in the outer surface of the container being relatively long relative to its width, the cavity incorporating guide means to guide an inserted sachet towards and into contact with the cutter, the abutment surface positioned to limit the extent to which a sachet can be inserted in the insertion direction into the cavity, the cutter configured such that the sachet is brought into contact with the cutter by a movement of the sachet within the cavity in the insertion direction, and then brought out of contact with the cutter by a reciprocal movement of the sachet in the withdrawal direction, the cutter having a cutting edge facing in the insertion direction to cut the sachet on the movement of the sachet in the withdrawal direction.

23. A dispenser according to claim 6, characterised by comprising a tetragonal container having a dispensing opening for the sachets at one surface of the container and the slot opening at the opposite surface, the slot opening comprising an aperture in the outer surface of the container being relatively long relative to its width, the cavity incorporating guide means to guide an inserted sachet towards and into contact with the cutter, the abutment surface positioned to limit the extent to which a sachet can be inserted in the insertion direction into the cavity, the cutter configured such that the sachet is brought into contact with the cutter by a movement of the sachet within the cavity in the insertion direction, and then brought out of contact with the cutter by a reciprocal movement of the sachet in the withdrawal direction, the cutter having a cutting edge facing in the insertion direction to cut the sachet on the movement of the sachet in the withdrawal direction.

24. A dispenser according to claim 7, characterised by comprising a tetragonal container having a dispensing opening for the sachets at one surface of the container and the slot opening at the opposite surface, the slot opening comprising an aperture in the outer surface of the container being relatively long relative to its width, the cavity incorporating guide means to guide an inserted sachet towards and into contact with the cutter, the abutment surface positioned to limit the extent to which a sachet can be inserted in the insertion direction into the cavity, the cutter configured such that the sachet is brought into contact with the cutter by a movement of the sachet within the cavity in the insertion direction, and then brought out of contact with the cutter by a reciprocal movement of the sachet in the withdrawal direction, the cutter having a cutting edge facing in the insertion direction to cut the sachet on the movement of the sachet in the withdrawal direction.

25. A dispenser according to claim 9, characterised by comprising a tetragonal container having a dispensing opening for the sachets at one surface of the container and the slot opening at the opposite surface, the slot opening comprising an aperture in the outer surface of the container being relatively long relative to its width, the cavity incorporating guide means to guide an inserted sachet towards and into contact with the cutter, the abutment surface positioned to limit the extent to which a sachet can be inserted in the insertion direction into the cavity, the cutter configured such that the sachet is brought into contact with the cutter by a movement of the sachet within the cavity in the insertion direction, and then brought out of contact with the cutter by a reciprocal movement of the sachet in the withdrawal direction, the cutter having a cutting edge facing in the insertion direction to cut the sachet on the movement of the sachet in the withdrawal direction.

26. A dispenser according to claim 10, characterised by comprising a tetragonal container having a dispensing opening for the sachets at one surface of the container and the slot opening at the opposite surface, the slot opening comprising an aperture in the outer surface of the container being relatively long relative to its width, the cavity incorporating guide means to guide an inserted sachet towards and into contact with the cutter, the abutment surface positioned to limit the extent to which a sachet can be inserted in the insertion direction into the cavity, the cutter configured such that the sachet is brought into contact with the cutter by a movement of the sachet within the cavity in the insertion direction, and then brought out of contact with the cutter by a reciprocal movement of the sachet in the withdrawal direction, the cutter having a cutting edge facing in the insertion direction to cut the sachet on the movement of the sachet in the withdrawal direction.

27. A dispenser according to claim 17, characterised by comprising a tetragonal container having a dispensing opening for the sachets at one surface of the container and the slot opening at the opposite surface, the slot opening comprising an aperture in the outer surface of the container being relatively long relative to its width, the cavity incorporating guide means to guide an inserted sachet towards and into contact with the cutter, the abutment surface positioned to limit the extent to which a sachet can be inserted in the insertion direction into the cavity, the cutter configured such that the sachet is brought into contact with the cutter by a movement of the sachet within the cavity in the insertion direction, and then brought out of contact with the cutter by a reciprocal movement of the sachet in the withdrawal direction, the cutter having a cutting edge facing in the insertion direction to cut the sachet on the movement of the sachet in the withdrawal direct.
